(19) United States
(12) Patent Application Publication
(10) Pub. No.: US 2002/0083058 A1
(43) Pub. Date: Jun. 27, 2002

(54) Method, apparatus and article for reference material management

(76) Inventors: Meng-Ling Hsiao, Niskayuna, NY (US); Lawrence D. Willey, Burnt Hills, NY (US)

Correspondence Address: PERKINS COIE LLP, 1201 3RD AVENUE, SUITE 4800, SEATTLE, WA, 98101-3099, US

(21) Appl. No.: 09/749,257

(22) Filed: Dec. 27, 2000

(51) Int. Cl. G06F 7/00

(52) U.S. Cl. 707/9

(57) ABSTRACT

Controlling on-line access to reference materials includes receiving a request for on-line access to a reference material, determining if the requested reference material is made available on limited basis or on an unlimited basis, providing on-line access to the requested reference material for the requester if the requested reference material is made available on an unlimited basis, determining if a copy of the requested reference material is available if the requested reference material is made available on a limited basis, providing on-line access to the requested material for the requester if a copy is available and temporarily denying on-line access to the requested material for the requester if a copy is not available. Controlling the updating of reference materials available on-line includes providing a limited access collection of reference materials, providing an unlimited access collection of reference materials, allowing only a central authority to update the limited access collection of reference materials, and allowing users to update the unlimited access collection of reference materials.

### TECHNICAL FIELD

This invention is generally related to the tracking and management of reference materials, and particularly to automated systems for managing on-line access to reference materials.

### BACKGROUND

Many companies rely on reference materials for research, development, business planning and other tasks. The reference materials typically take the form of journals, articles, periodicals, codes, standards, books, graphs, charts, maps, sound recordings and video. Often these materials are copyrighted subject matter, and their use is subject to control by the copyright owner. Where the copyright owner is not associated with the company, the company may have to purchase the reference materials and/or receive a license for the use of the reference material. Typically, purchase of a copy of a copyrighted work does not permit the making of multiple copies of the work. Where the copyright owner is associated with the company, the copyright in the work may belong to the company or the company may have an unlimited right to make copies of the work. The management of reference materials, particularly for large companies, can be extremely complex and time consuming. The problem is exacerbated by the desire to make the reference materials available on-line. In some instances, it may be difficult to differentiate between reference materials which may not be copied and those reference materials which may be copied in unlimited numbers. In some instances, it may be difficult to manage the number of copies of a reference material where more than one copy is permitted by license or by law.

### SUMMARY

In one aspect, a method of controlling on-line access to reference materials includes receiving an on-line request, determining if a copy of the requested reference material is available, providing access to the copy of the requested material if available, and temporarily denying access to the requested reference material if not available. The presence of a token can identify the availability of copies of the reference material, where the token is passed to the requester if the reference material is available, and returned when the requester has finished accessing the reference material.

In another aspect, a method of controlling on-line access to reference materials includes providing view access to requested materials if the requested reference materials are made available on an unlimited basis, providing view access to the requested reference material if the requested reference material is made available on a limited basis and a number of requesters having access is below a maximum number, and temporarily denying view access to the requested material if the requested material is made available on a limited basis and the number of requesters having access is at least equal to the maximum number.

In another aspect, a method of controlling on-line access to reference materials includes receiving a request for on-line access to a reference material from a requester, determining if the requested reference material is made available on limited basis or on an unlimited basis, if the requested reference material is made available on an unlimited basis , providing on-line access to the requested reference material for the requester, if the requested reference material is made available on a limited basis, determining if all copies of the requested reference material are currently checked out, if the requested reference material is made available on a limited basis and all copies of the requested reference material are not currently checked out, providing on-line access to the requested material for the requester, and if the requested reference material is made available on a limited basis and all copies of the requested reference material are currently checked out, temporarily denying on-line access to the requested material for the requester.

In a further aspect, a method of controlling on-line access to reference materials includes providing a limited access collection of reference materials made available as on-line copies to requesting users on a limited basis, providing an unlimited access collection of reference materials made available as on-line copies to requesting users on an unlimited basis, allowing only a central authority to update the limited access collection of reference materials, and allowing users to update the unlimited access collection of reference materials.

In a further aspect, a system for providing access to reference materials includes a limited access collection of reference materials, the reference materials in the limited access collection of reference materials being made available on a limited basis, an unlimited access collection of reference materials, the reference materials in the unlimited access collection of reference materials being made available on an unlimited basis, an interface that receives on-line requests for one or more of the reference materials; and a processor programmed to: determine if the requested reference material is in the limited access collection of reference materials or the unlimited access collection of reference materials, if the requested reference material is in the unlimited access collection of reference materials, provide on-line access to the requested reference material for the requester, if the requested reference material is in the limited access collection, determine if all copies of the requested reference material are currently checked out, if the requested reference material is in the limited access collection of reference materials and all copies of the requested reference material are not currently checked out, provide on-line access to the requested material for the requester, and if the requested reference material is in the limited access collection of reference materials and all copies of the requested reference material are currently checked out, temporarily deny on-line access to the requested material for the requester.

In yet a further aspect, a system for providing access to reference materials includes a limited access collection of reference materials, the reference materials in the limited access collection of reference materials being made available on a limited basis, an unlimited access collection of reference materials, the reference materials in the unlimited access collection of reference materials being made available on an unlimited basis, an interface that receives on-line requests for one or more of the reference materials; and a processor programmed to: allow only a central authority to update the limited access collection of reference materials, and allow users to update the unlimited access collection of reference materials.

In yet another aspect, a computer-readable media causes a computer to provide controlled access to reference materials by: receiving an on-line request for a reference material, determining if a copy of the requested reference material is available, providing access to the copy of the requested reference material if the requested reference material is available, and temporarily denying access to the requested reference material if the requested reference material is not available.

In yet another aspect, computer-readable media that causes a computer to provide controlled access to reference materials, by: receiving a request for on-line access to a reference material from a requester, determining if the requested reference material is made available on limited basis or on an unlimited basis, if the requested reference material is made available on an unlimited basis, providing on-line access to the requested reference material for the requester, if the requested reference material is made available on a limited basis, determining if all copies of the requested reference material are currently checked out, if the requested reference material is made available on a limited basis and all copies of the requested reference material are not currently checked out, providing on-line access to the requested material for the requester, and if the requested reference material is made available on a limited basis and all copies of the requested reference material are currently checked out, temporarily denying on-line access to the requested material for the requester.

In yet another aspect, computer-readable media that causes a computer to provide controlled access to reference materials, by: providing a limited access collection of reference materials made available as on-line copies to requesting users on a limited basis, providing an unlimited access collection of reference materials made available as on-line copies to requesting users on an unlimited basis, allowing only a central authority to update the limited access collection of reference materials, and allowing users to update the unlimited access collection of reference materials.

### BRIEF DESCRIPTION OF DRAWINGS

In the drawings, identical reference numbers identify similar elements or acts. The size and relative positions of elements in the drawings are not necessarily drawn to scale. For example, the shapes of various elements are not drawn to scale, and some of these elements are arbitrarily enlarged and positioned to improve drawing legibility. Further, the particular shapes of elements, as drawn are not intended to convey any information regarding the actual shape of the particular elements, and have been solely selected for their ease and recognition in the drawings.

FIG. 1 is a schematic drawing showing an environment in which an embodiment of the invention can operate, including a network coupling a number of client computing systems and a server computing system.

FIG. 2 is a high level system block diagram showing various hardware elements of the client computing systems of FIG. 1.

FIG. 3 is a functional block diagram of an embodiment employing the World Wide Web portion of the Internet to provide controlled on-line access to reference materials.

FIG. 4 is a flow diagram of an illustrated method of providing controlled online access to reference materials according to one embodiment of the invention employing the reference material access system of FIG. 1.

FIG. 5 is a flow diagram of another illustrated method of providing controlled on-line access to reference materials according to one embodiment of the invention employing the reference material access system of FIG. 3.

FIG. 6 is a flow diagram of an illustrated method of updating reference material collections according to one embodiment of the invention employing the reference material access system of FIG. 1.

### DETAILED DESCRIPTION

In the following description, certain specific details are set forth in order to provide a thorough understanding of various embodiments of the invention. However, one skilled in the art will understand that the invention may be practiced without these details. In other instances, well-known structures associated with computers, computer networks, data structures, databases and networks such as the Internet, have not been described in detail to avoid unnecessarily obscuring the descriptions of the embodiments of the invention.

Unless the context requires otherwise, throughout the specification and claims which follow, the word “comprise” and variations thereof, such as “comprises” and “comprising” are to be construed in an open, inclusive sense, that is as “including but not limited to.”

System Environment

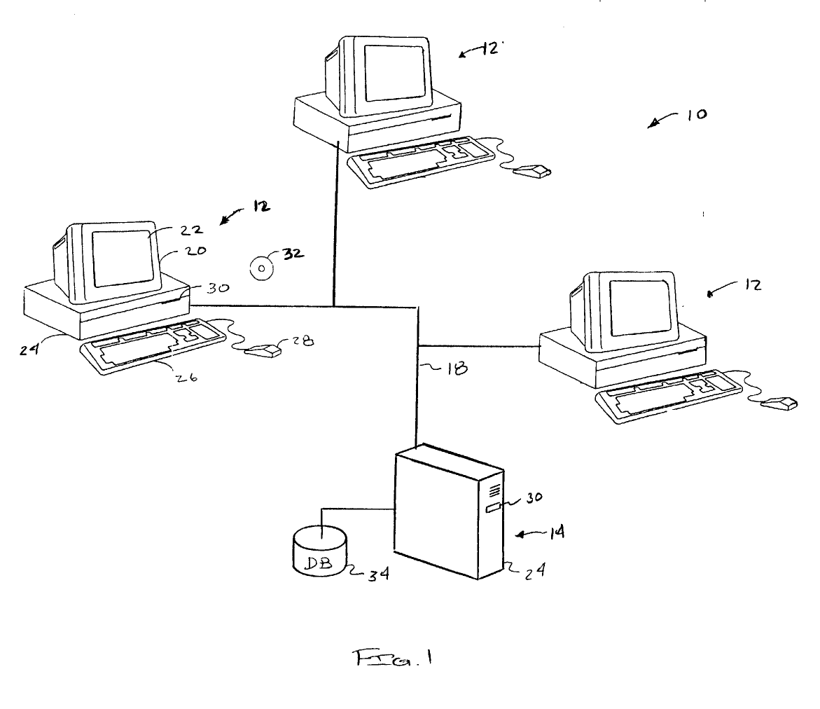

FIG. 1 shows a reference material access system 10 including a number of client computing systems 12 and a server computing system 14 that communicate over a network 18. The client computing systems 12 each include a display 20, screen 22, cabinet 24, keyboard 26 and mouse 28. The mouse 28 can have one or more user selectable buttons for interacting with a graphical user interface (“GUI”) displayed on the screen 22. The cabinet 24 includes a slot 30 for receiving computer-readable media, such as a CD-ROM disk 32. Although the computer-readable media is represented as a CD-ROM disk 32, the reference material access system 10 can employ other computer-readable media, including but not limited to, floppy disks, tape, flash memory, system memory, and hard drives.

The server computing system 14 includes a cabinet 24 having a slot 30 for receiving computer-readable media, such as a CD-ROM disk similar to the CD-ROM disk 32. The server computing system 14 can optionally include a display, screen, keyboard, and/or mouse as described above. The server computing system 14 also includes a server database 34. The server database 34 is shown as being external to the cabinet 24 for ease of representation in the drawings, although in many embodiments the server database 34 can be located within the cabinet 24.

The network 18 can take the form of any conventional network, such as one or more local area networks (“LANs”), wide area networks (“WANs”), and/or extranets, intranets, or the Internet.

Low-level System

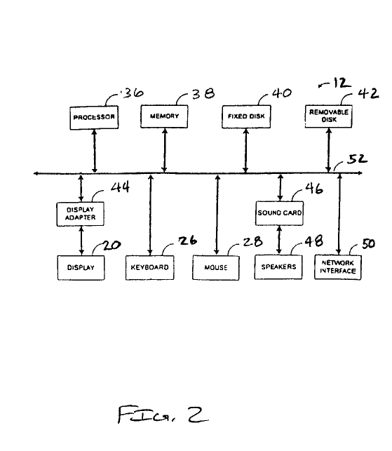

FIG. 2 shows a system block diagram of the client computing systems 12 used in executing an illustrated embodiment of the present invention. As in FIG. 1, the client computing systems 12 each include the display 20, keyboard 26 and mouse 28. Additionally, each of the client computing systems 12 can include subsystems, such as a processor 36, system memory 38, fixed persistent memory 40, media drive 42, display adapter 44, sound card 46, speakers 48, and network interface 50. Arrows 52 represent the system bus architecture of the client computing systems 12.

The client computing systems 12 can take any of a variety of forms, such as a micro- or personal computer, a mini-computer, a workstation, or a palm-top or hand-held computing appliance. The processor 36 can take the form of any suitable microprocessor, for example, a Pentium II, Pentium III, Pentium IV, AMD Athlon, Power PC 603 or Power PC 604 processor. The system memory 38 can take the form of random access memory (“RAM”) or other dynamic storage that temporarily stores instructions and data for execution by the processor 36. The fixed persistent memory 40 can take the form of a hard drive or other nonvolatile computer-readable media. The media drive 42 can take the form of a CD-ROM reader, a DVD reader and optical disk reader, floppy disk reader, or other similar device that reads instructions and/or data from computer-readable media.

While not shown in detail, the server computing system 14 can have a similar structure to the client computing systems 12, as shown in FIG. 2. In practice, the server computing system will typically take the form of a network server such as a Web server, the details of which are commonly understood by those skilled in the art.

The computing systems 12, 14 are illustrative of the numerous computing systems suitable for use with the present invention. Other suitable configurations of computing systems will be readily apparent to one of ordinary skill in the art. Other configurations can include additional subsystems, or fewer subsystems, as is suitable for the particular application. For example, a suitable computing system 12, 14 can include more than one processor 36 (i.e., a multiprocessor system) and/or a cache memory. The arrows 52 are illustrative of any interconnection scheme serving to link the subsystems. Other suitable interconnection schemes will be readily apparent to one skilled in the art. For example, a local bus could be utilized to connect the processor 36 to the system memory 38 and the display adapter 34.

Reference Material Access Overview

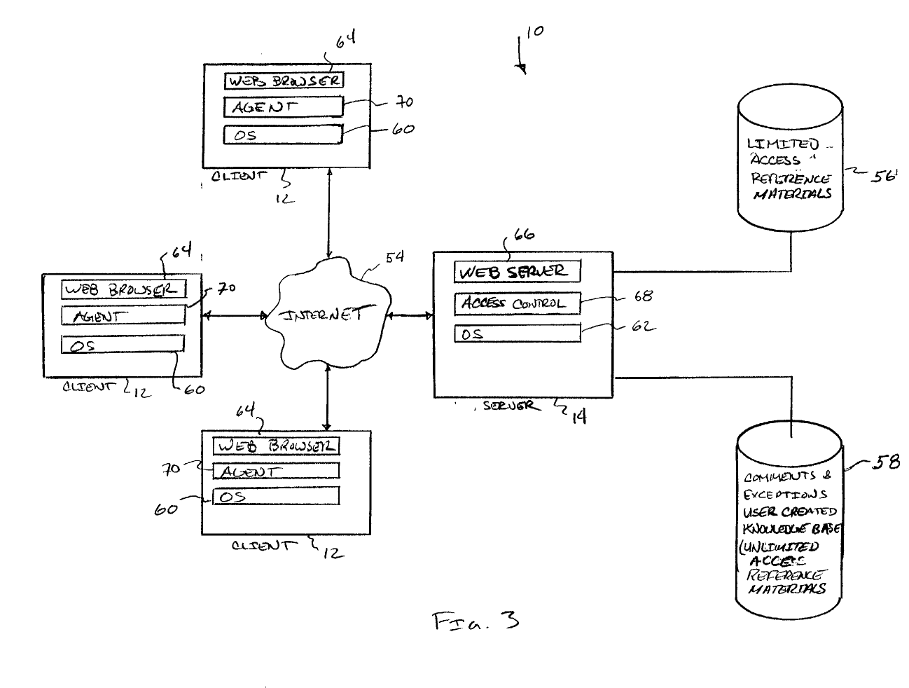

FIG. 3 shows an embodiment of the reference material access system 10 employing the World Wide Web portion of the Internet 54 for providing on-line access to reference materials. As discussed above, reference materials can include journals, articles, periodicals, codes, standards, papers, books, graphs, charts, maps, sound or audio recordings and video, although this list is not meant to be exhaustive. The reference materials can include materials in any format useful to the user. The reference materials can also cover any subject useful to the user.

For many reference materials, limitations may exist on the number of copies which a company, or other entity, can possess or distribute at an given time. Often, the company will only have the right to distribute a single copy of the reference material. In other instances, the company will have the right to distribute more than one copy of the reference material, but not an unlimited number of copies. Some reference materials may not be subject to limitations on the number of copies which the company can distribute. For example, materials which are in the public domain may be freely copied and distributed. Often the company will have the right to make unlimited distribution of reference materials produced by the company's employees and/or contractors. For examples, reports, comments and/or notes made by the company's employees regarding a variety of subjects, including other reference materials which are themselves subject to the limitations on copying.

The reference material access system 10 differentiates between reference materials subject to limitations on the number of copies that can be distributed and reference materials that are not subject to such limitations. As shown in FIG. 3, the reference materials subject to limitations on the number of copies that can be distributed form a limited access collection of reference materials 56, while the reference materials not subject to the limitation form an unlimited access collection of reference materials 58. While illustrated as separate databases in FIG. 3, the reference material access system 10 can store all limited access and unlimited access reference materials in a single storage device. Alternatively, the reference material access system 10 can distribute the limited access and unlimited access reference materials between two or more storage devices without regard to copying limitations. In such a situation, the reference material access system 10 must track the limitation status of each reference material, for example, using a master database to track the storage location and limitation status of each reference material.

Software

The system memory 38 of the client computing system 12 and server computing system 14 contain instructions and data for execution by the respective processors 36 for implementing the illustrated embodiments. For example, the system memory 38 includes an operating system (“OS”) to provide instructions and data for operating the respective computing systems 12, 14. In the case of the client computing systems 12, the OS 60 can take the form of conventional operating systems, such as WINDOWS 95, WINDOWS 98, WINDOWS NT 4.0 and/or WINDOWS 2000, available from Microsoft Corporation of Redmond, Wash. In the case of the server computing system 14, the OS 62 can take the form of conventional server operating systems, such as WINDOWS NT 4.0 Server, and/or WINDOWS 2000 Server, also available from Microsoft Corporation. The OS 60, 62 can include application programming interfaces (“APIs”) (not shown) for interfacing with the various subsystems and peripheral components of the computing systems 12, 14, as is conventional in the art. For example, the OS 60, 62 can include APIs (not shown) for interfacing with a display 20, 44, keyboard 26, window, sound 46, 48, and communications 50 subsystems.

The system memory 38 of the client and server computing systems 12, 14 can also include additional communications or networking software (not shown) for wired and/or wireless communications on networks, such as local area networks (“LANs”), wide area networks (“WANs”), or the Internet. For example, the client computing system 12 can include a Web client or browser 64 for communicating across the World Wide Web portion of the Internet 18 using standard protocol (e.g., Transmission Control Protocol/Internet Protocol (TCP/IP), User Datagram Protocol (UDP)). A number of Web browsers are commercially available, such as NETSCAPE NAVIGATOR from America Online, and INTERNET EXPLORER available from Microsoft of Redmond, Wash. The server computing system 14 can include a Web server 66, such as any of the many commercially available Web server applications.

The system memory 38 of the server computing system 14 also includes instructions and/or data in the form of an access control application 68 for controlling the distribution of copies of the reference materials to the users. The access control application 68, determines whether the requested material is from the limited or unlimited collections of reference materials 56, 58, respectively. If the requested reference material is from the unlimited collection 58, the access control application 68 makes the requested reference material available on-line to the requesting user. For example, the access control application 68 can cause an electronic copy of the requested material to be transferred to the requesting user in a format suitable to the requesting user's client computing system 12. If the requested reference material is from the limited collection 56, the access control application 68 determines whether a copy can be provided to the requesting user without exceeding a limit on the number of copies of the reference material which the company can distribute. For example, the access control application 68 can compare a number of available copies to a number of copies currently in use. Alternatively, as explained in detail below, the access control application 68 can check a checked in/check out status in a database to determine the availability of a copy of the requested reference material. Alternatively, as explained in detail below, the access control application 68 can determine whether the server computing system 14 has possession of a token corresponding to a copy of the requested reference material.

Additionally, the access control application 68, in conjunction with the operating system 60 and the APIs of the client computing systems 12, provide the UI that aides the users in requesting and receiving the reference materials on-line.

The system memory 38 of the client computing system 12 can also include instructions and/or data in the form of an agent 70 for tracking use of the requested materials by the requesting user and for providing notification to the access control application 68 on the server computing system 14 when the client computing system 12 no longer has access to the requested reference material. For example, the client computing system 12 can monitor the contents of a viewing application program or a Web browser to determine when the requested reference material is no longer available for viewing. The client computing system 12 can then transmit a message, or pass a token, to the server computing system 14 to indicate that the copy of the requested reference material is no longer in use.

The agent 70 can be an integral part of the Web browser 64, or can be a Web browser plug-in designed to provide additional functionality to the Web browser. Alternatively, the agent 70 can be an extension to the OS 60 of client computing system 12, or a stand alone application, for example, where the reference material access system 10 employs a network structure other than the World Wide Web. The server computing system 14 can download the agent 70 to the client computing system 12 as a discrete component, or can download the agent 70 to the client computing system 12 as part of the requested reference material. For example, the server computing system 14 can transfer the agent 70 to the client computing system 12 in the form of a Java Applet, Java Servlet, Active Server Page (ASP), or Common Gateway Interface (CGI) program as a portion of a Web page, which may, or may not, include some or all of the requested reference material.

Exemplary Methods of Operation

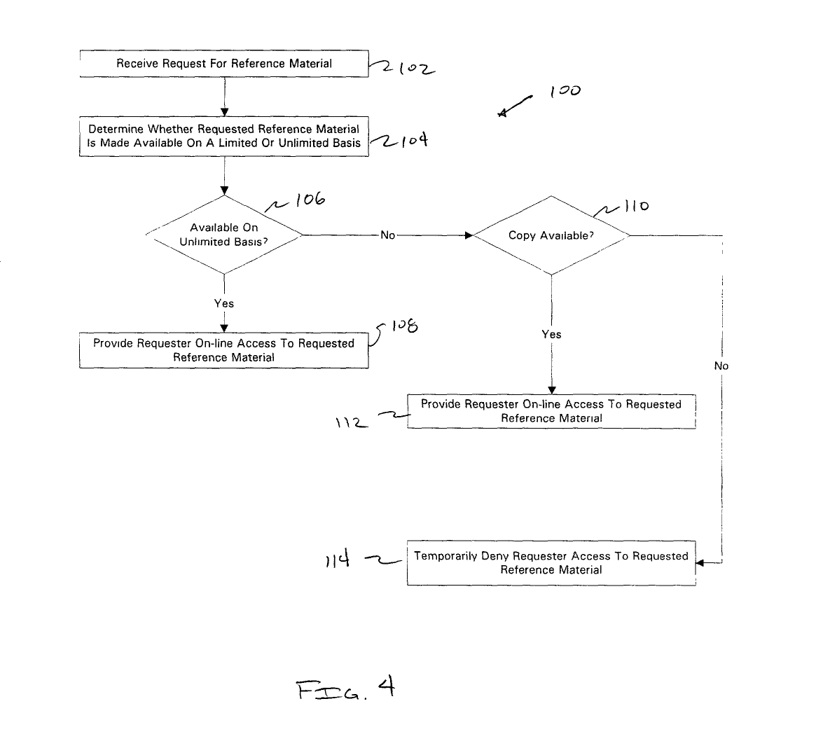

FIG. 4 shows an exemplary method 100 of operation for the reference material access system 10. In step 102, the server computing system 14 receives a request from a client computing system 12 for a particular reference material. The server computing system 14 can maintain a list of all reference materials in the limited and/or unlimited collections 56, 58, respectively. The list can include title, author, abstract, keyword and/or other parameters. Alternatively, and/or additionally, the server computing system 14 can maintain a database of all reference materials in the limited and/or unlimited collections 56, 58, respectively, including user accessible search routines for quickly determining whether the collections 56, 58 include suitable reference material and/or identifying the particular reference material.

In step 104, the server computing system 14 determines whether the requested reference material is made available on a limited or unlimited basis. That is, whether or not the requested reference material is subject to limitations on the number of copies which may be distributed. In one embodiment, the server computing system 14 determines whether the requested reference material is made available on a limited or unlimited basis by querying a database that includes such information about all of the reference materials 56, 58. In an alternative embodiment, the server computing system 14 can determine whether the requested reference material is made available on a limited or unlimited basis by determining the storage location of the requested reference material, where the reference materials are segregated according to such criteria. In still another alternative embodiment, the server computing system 14 can determine whether the requested reference material is made available on a limited or unlimited basis by determining the same from tags or attributes encoded in each of the reference material data files in the knowledge base. If the requested reference material is available on an unlimited basis, in step 106 the server computing system 14 passes control to step 108, where the server computing system 14 provides the requester with on-line access to the requested reference material.

If the requested reference material is available on a limited basis, in step 106 the server computing system 14 passes control to step 110. In step 110, the server computing system 14 determines whether a copy of the requested reference material is available for distribution. For example, the server computing system 14 can compare a number of available copies to a number of copies currently in use. Alternatively, the server computing system 14 can check a checked in/check out status in a database that tracks the status and/or location of the various reference materials to determine the availability of a copy of the requested reference material. Alternatively, as explained in more detail below, the server computing system 14 can determine whether it has possession of a token corresponding to a copy of the requested reference material.

If the server computing system 14 determines that a copy of the requested reference material is available for distribution, the server computing system 14 provides the requester with on-line access to the requested reference material in step 112. If the server computing system 14 determines that a copy of the requested reference material is not available for distribution (e.g., no copy available and/or all copies in use), the server computing system 14 temporarily denies the requester access to the requested reference materials in step 114. The server computing system 14 can cause the client computing system 12 to display a message informing the user that the requested reference material is not presently available, and/or the reason for the temporary unavailability.

The server computing system 14 can monitor the status of the requested reference material, providing access to the requester when the requested reference material becomes available, or times-out due to a prescribed idle time period being detected at the user Web browser 64, and/or providing notice to the requester of the availability of the requested materials at such time.

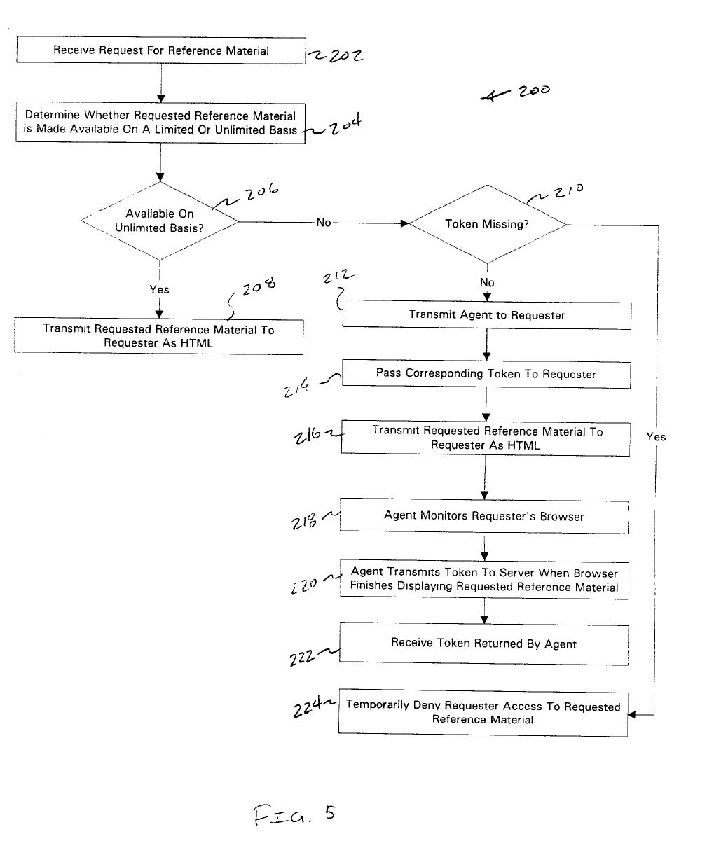

FIG. 5 shows another exemplary method 200 of operation for the reference material access system 10. In step 202, the server computing system 14 receives a request from a client computing system 12 for a particular reference material. As discussed above, the server computing system 14 can maintain a list of all reference materials in the limited and/or unlimited collections 56, 58, respectively. Also as discussed above, the server computing system 14 can alternatively, or additionally maintain a database of all reference materials in the limited and/or unlimited collections 56, 58, respectively, including user accessible search routines for quickly determining whether the collections 56, 58 include suitable reference material and/or identifying the particular reference material.

In step 204, the server computing system 14 determines whether the requested reference material is made available on a limited or unlimited basis. That is, whether or not the requested reference material is subject to limitations on the number of copies which may be distributed. If the requested reference material is available on an unlimited basis, in step 206 the server computing system passes control to step 208, where the server computing system 14 provides the requester with on-line access to the requested reference material.

If the requested reference material is available on a limited basis, in step 106 the server computing system passes control to step 210. In step 210, the server computing system 14 determines whether a token representing control of the reference material is missing. If a token is found, then a copy of the requested reference material is available for distribution. If a token is not found, then no copies of the requested reference material is available for distribution at the current time. As explained below, the token can be passed to the requesting client computing system 12 to hold while the requesting user has possession or control over the copy of the requested reference material. The agent 70 can cause the client computing system 12 to return the token to the server computing system 14 when the user is finished viewing the requested reference material or prescribed idle time period has elapsed, in effect “returning” the copy for further circulation. In some embodiments, the client computing system 12 will return the actual electronic copy of the requested reference material, while in other embodiments the client computing system 12 will simply render the electronic copy irretrievable.

In step 212, the server computing system 14 transmits an agent 70 to the requesting client computing system 12. As discussed above, the agent 70 can be transmitted with, or separately from, the requested reference material. In the illustrated example, the agent 70 is transmitted prior to the passing of the token and/or reference material to ensure that the necessary components are loaded onto the client computing system before providing access to limited access reference material. This helps ensure the integrity of the reference material access system 10.

In step 214, the server computing system 14 passes the token for the requested reference material to the requesting client computing system 12. In step 216, the server computing system 14 transmits the requested reference material to the requesting client computing system 12 in the form of one or more HTML or other digital electronic computer files (e.g., PDF, DOC, XLS, etc.).

In step 218, the agent 70 on the requesting client computing system 12 monitors the Web browser 64 to detect when the reference material computer files (e.g., HTML files) are no longer available to the Web browser 64 for display to the user. In step 220, the agent 70 transmits the token back to the server computing system 14 when the reference material computer files are no longer available to the Web browser 64, thus returning control over the copy of the reference material to the server computing system 14. In step 222, the server computing system 14 receives the token from the client computing system 12.

If the server computing system 14 finds the token missing in step 210, the server computing system 14 temporarily denies access to the requested reference material in step 224. The server computing system 14 can cause the Web browser 64 on the requesting client computing system 12 to display a message informing the user that the requested reference material is not presently available. Again, the server computing system 14 can monitor the status of the requested reference material, providing the reference material and/or notice to the requesting user once a copy of the requested reference material becomes available. Additionally, the server computing system 14 can track the number of requests for the various reference materials, and/or the number of times that a user is denied access to the reference materials to allow the company to better assess its needs for the reference materials. Additionally, the idle time value can be incrementally reduced to a minimum value or returned to the prescribed nominal value in real time based on the number of request for specific reference materials. Thus, a company can choose to eliminate or reduce the number of copies of some reference materials which have limited demand, while increasing the number of copies for reference materials in high demand. Eliminated reference materials are moved from the database 34 into a less frequently accessed historical archive database to improve the primary system performance without loss of the reference material availability or the knowledge base content.

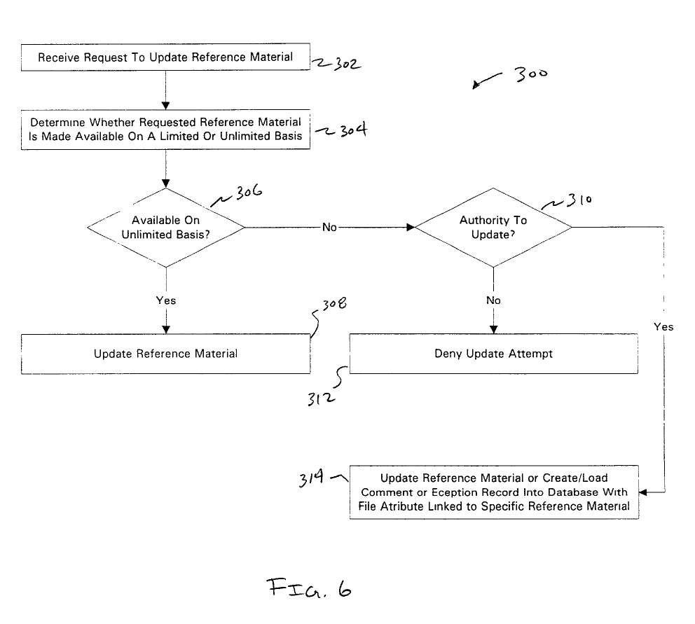

FIG. 6 shows an exemplary method 300 of updating reference materials on the reference material access system 10. Updating reference materials includes associative collection of separate comment and exception data files linked to specific reference materials in addition to tracked revision levels of the actual reference materials.

In step 302, the server computing system 14 receives a request to update reference material. In step 304, the server computing system 14 determines whether the requested reference material is made available on a limited or unlimited basis. That is, whether or not the requested reference material is subject to limitations on the number of copies which may be distributed. If the requested reference material is made available on an unlimited basis, the server computing system in step 306 passes control to step 308, where the server computing system 14 updates the reference material. The server computing system 14 can perform additionally security checking (e.g., user identifiers, passwords, etc.) where suitable.

If the requested reference material is made available on a limited basis, the server computing system in step 306 passes control to step 310. In step 310, the server computing system 14 determines whether the requesting user has authority to update the reference material. The server computing system 14 can employ an identifier the identifies the requesting user and a secured database of permission levels for various users to determine authority.

If the requesting user does not have authority to update the reference material, the server computing system 14 denies the update attempt in step 312. The server computing system 14 can notify the requesting user of the denial, and/or the reason for denial. The server computing system can notify a system administrator or other person in authority of the denied request, and/or the identity of the denied requesting user. If the requesting user has authority to update the reference material, the server computing system 14 updates the reference material in step 314. The update may take the form of replacing some or all of the particular reference material. The update may additionally, or alternatively, take the form of a “redline” update of the particular reference, allowing users to easily track changes to made to the reference materials. Additionally, or alternatively, the update may take the form of a new comment or exception record that includes file attributes linking the comment or exception record to one or more specific reference material files.

### SUMMARY

Although specific embodiments, and examples for, the invention are described herein for illustrative purposes, various equivalent modifications can be made without departing from the spirit and scope of the invention, as will be recognized by those skilled in the relevant art. The teachings provided herein of the invention can be applied to other networked systems for controlling on-line distribution or access to materials. For example, the teachings can employ networks other than the World Wide Web portion of the Internet. The various embodiments described above can be combined to provide further embodiments. The described methods can omit some acts, can add other acts, and can execute the acts in a different order than that illustrated, to achieve the advantages of the invention.

These and other changes can be made to the invention in light of the above detailed description. In general, in the following claims, the terms used should not be construed to limit the invention to the specific embodiments disclosed in the specification, but should be construed to include all computers, networks and access or distribution systems that operate in accordance with the claims. Accordingly, the invention is not limited by the disclosure, but instead its scope is to be determined entirely by the following claims.

1. A method of controlling on-line access to reference materials, comprising:
receiving an on-line request for a reference material;
determining if a copy of the requested reference material is available;
providing access to the copy of the requested reference material if the requested reference material is available; and
temporarily denying access to the requested reference material if the requested reference material is not available.

2. The method of claim 1 wherein providing access to the copy of the requested reference material includes transmitting the copy of the requested reference material as a digital electronic file.

3 . The method of claim 1 wherein providing access to the copy of the requested reference material includes transmitting the copy of the requested reference material as HTML.

4. The method of claim 1 wherein providing access to the copy of the requested reference material includes transmitting the copy of the requested reference material as HTML including a client side agent programmed to provide an indication when the transmitted copy of the requested reference material has been replaced.

5 . The method of claim 1, further comprising:
receiving an indication when access to the copy of the requested material is terminated.

6. The method of claim 1, further comprising:
passing a token if a copy of the requested material is available; and
receiving an indication in the form of a return of the token when access to the copy of the requested material is terminated.

7. The method of claim 1, further comprising:
monitoring a client side browser to determine when an image of the requested reference materials has been replaced.

8. The method of claim 1, further comprising:
monitoring a client side browser to determine when the client side browser has been idle for a prescribed period of time.

9. The method of claim 1 wherein determining if a copy of the requested reference material is available includes comparing a number of copies of the requested reference materials to which access is currently being provided with a maximum number of copies of the requested reference materials for which access can contractually be provided.

10. The method of claim 1 wherein determining if a copy of the requested reference material is available includes determining if a server has possession of a token corresponding to the requested reference materials.

11. A method of providing access to reference materials, comprising:
providing view access to a requested reference material if the requested reference material is made available on an unlimited basis;
providing view access to the requested reference material if the requested reference material is made available on a limited basis and a number of requesters currently having view access to the requested reference material is less than a defined maximum number of concurrent viewers for the requested reference material; and
temporarily denying view access to the requested reference material if the requested reference material is made available on a limited basis and the number of requesters currently having view access to the requested reference material is at least equal to the defined maximum number of concurrent viewers for the requested reference material.

12. The method of claim 11, further comprising:
receiving an indication from a client side agent in the form of a return of a token when the copy of the requested reference material has been replaced in a client side browser.

13. The method of claim 11, further comprising:
transmitting a client side agent from a server to a client requesting the requested reference material; and
receiving an indication from the client side agent when the copy of the requested reference material has been replaced in a client side browser.

14. The method of claim 11 wherein the requested reference material is at least one of a text segment, a video segment and an audio segment.

15. A method of providing access to reference material, comprising:
receiving a request for on-line access to a reference material from a requester;
determining if the requested reference material is made available on limited basis or on an unlimited basis;
if the requested reference material is made available on an unlimited basis, providing on-line access to the requested reference material for the requester;
if the requested reference material is made available on a limited basis, determining if all copies of the requested reference material are currently checked out;
if the requested reference material is made available on a limited basis and all copies of the requested reference material are not currently checked out, providing on-line access to the requested material for the requester; and
if the requested reference material is made available on a limited basis and all copies of the requested reference material are currently checked out, temporarily denying online access to the requested material for the requester.

16. The method of claim 15 wherein determining if all copies of the requested reference material are currently checked out includes determining whether a server has possession of a token corresponding to the requested reference materials.

17. The method of claim 15 wherein providing on-line access to the requested material for the requester includes transmitting a computer-readable copy of the requested material to a requester's computer.

18. The method of claim 15, further comprising:
receiving an indication when the requester has finished accessing the requested material.

19. The method of claim 15, further comprising:
passing possession of a token corresponding to the requested reference material from a server to the requester each time that on-line access to the requested material for the requester is provided if the requested reference material is made available on a limited basis
receiving an indication in the form of a return of the token corresponding to the requested reference material each time the requester has finished accessing the requested material.

20. A method of providing access to materials, comprising:
providing a limited access collection of reference materials made available as on-line copies to requesting users on a limited basis;
providing an unlimited access collection of reference materials made available as on-line copies to requesting users on an unlimited basis;
allowing only a central authority to update the limited access collection of reference materials; and
allowing users to update the unlimited access collection of reference materials.

21. The method of claim 20 wherein allowing only a central authority to update the limited access collection of reference materials includes allowing only the central authority to add additional reference materials to the limited access collection of reference materials.

22. The method of claim 20 wherein allowing only a central authority to update the limited access collection of reference materials includes allowing only the central authority to modify at least one of the additional reference materials in the limited access collection of reference materials.

23. The method of claim 20 wherein allowing users to update the unlimited access collection of reference materials includes allowing users to add additional reference materials to the unlimited access collection of reference materials.

24. The method of claim 20 wherein allowing users to update the unlimited access collection of reference materials includes allowing users to modify at least one of the additional reference materials in the unlimited access collection of reference materials.

25. The method of claim 20, further comprising:
providing a user interface for requesting one or more of the reference materials as on-line copies.

26. The method of claim 20, further comprising:
receiving a request for on-line access to a reference material from a requester;
determining if the requested reference material is in the limited access collection of reference materials or the unlimited access collection of reference materials;
if the requested reference material is in the unlimited access collection of reference materials, providing on-line access to the requested reference material for the requester;
if the requested reference material is in the limited access collection, determining if all copies of the requested reference material are currently checked out;
if the requested reference material is in the limited access collection of reference materials and all copies of the requested reference material are not currently checked out, providing on-line access to the requested material for the requester; and
if the requested reference material is in the limited access collection of reference materials and all copies of the requested reference material are currently checked out, temporarily denying on-line access to the requested material for the requester.

27. A system for providing access to reference materials, comprising:
a limited access collection of reference materials, the reference materials in the limited access collection of reference materials being made available on a limited basis;
an unlimited access collection of reference materials, the reference materials in the unlimited access collection of reference materials being made available on an unlimited basis;
an interface that receives on-line requests for one or more of the reference materials; and
a processor programmed to:
determine if the requested reference material is in the limited access collection of reference materials or the unlimited access collection of reference materials;
if the requested reference material is in the unlimited access collection of reference materials, provide on-line access to the requested reference material for the requester;
if the requested reference material is in the limited access collection, determine if all copies of the requested reference material are currently checked out;
if the requested reference material is in the limited access collection of reference materials and all copies of the requested reference material are not currently checked out, provide on-line access to the requested material for the requester; and
if the requested reference material is in the limited access collection of reference materials and all copies of the requested reference material are currently checked out, temporarily deny on-line access to the requested material for the requester.

28. The system of claim 27 wherein the reference materials include at least one of video materials, audio materials, and textual materials.

29. A system for providing access to reference materials, comprising:
a limited access collection of reference materials, the reference materials in the limited access collection of reference materials being made available on a limited basis;
an unlimited access collection of reference materials, the reference materials in the unlimited access collection of reference materials being made available on an unlimited basis;
an interface that receives on-line requests for one or more of the reference materials; and
a processor programmed to:
allow only a central authority to provide additional reference materials for inclusion as part of the limited access collection of reference materials; and
allow users to provide additional reference materials for inclusion as part of the unlimited access collection of reference materials.

30. A computer-readable media that causes a computer to provide controlled access to reference materials, by:
receiving an on-line request for a reference material;
determining if a copy of the requested reference material is available;
providing access to the copy of the requested reference material if the requested reference material is available; and
temporarily denying access to the requested reference material if the requested reference material is not available.

31. A computer-readable media that causes a computer to provide controlled access to reference materials, by:
providing view access to a requested reference material if the requested reference material is made available on an unlimited basis;
providing view access to the requested reference material if the requested reference material is made available on a limited basis and a number of requesters currently having view access to the requested reference material is less than a defined maximum number of concurrent viewers for the requested reference material; and
temporarily denying view access to the requested reference material if the requested reference material is made available on a limited basis and the number of requesters currently having view access to the requested reference material is at least equal to the defined maximum number of concurrent viewers for the requested reference material.

32. A computer-readable media that causes a computer to provide controlled access to reference materials, by:
receiving a request for on-line access to a reference material from a requester;
determining if the requested reference material is made available on limited basis or on an unlimited basis;
if the requested reference material is made available on an unlimited basis, providing on-line access to the requested reference material for the requester;
if the requested reference material is made available on a limited basis, determining if all copies of the requested reference material are currently checked out;
if the requested reference material is made available on a limited basis and all copies of the requested reference material are not currently checked out, providing on-line access to the requested material for the requester; and
if the requested reference material is made available on a limited basis and all copies of the requested reference material are currently checked out, temporarily denying online access to the requested material for the requester.

33. A computer-readable media that causes a computer to provide controlled access to reference materials, by:
providing a limited access collection of reference materials made available as on-line copies to requesting users on a limited basis;
providing an unlimited access collection of reference materials made available as on-line copies to requesting users on an unlimited basis;
allowing only a central authority to provide update the limited access collection of reference materials; and
allowing users to provide update the unlimited access collection of reference materials.
